(19) United States
(12) Patent Application Publication
(10) Pub. No.: US 2004/0249617 A1
(43) Pub. Date: Dec. 9, 2004

(54) Selective, pregressive transmission of 3D geometry models with the pre-ordered hierarchical meshes

(75) Inventors: Wing Hung Lau, Kowloon (HK); Danny Kilis, Quarry Bay (HK); Woon Bor Li, Tai Po (HK); Yin Fai Tsang, Kwun Tong (HK)

Correspondence Address: LEYDIG VOIT & MAYER, LTD, 700 THIRTEENTH ST. NW, SUITE 300, WASHINGTON, DC, 20005-3960, US

(73) Assignee: PCCW-HKT DataCom Services Limited, Quarry Bay (HK)

(21) Appl. No.: 10/452,130

(22) Filed: Jun. 3, 2003

(51) Int. Cl. G06F 17/10

(52) U.S. Cl. 703/2

(57) ABSTRACT

An efficient hierarchical multi-resolution method based on Hierarchical Meshes (HM) supports selective and progressive transmission and rendering of 3D geometric models. Methods are disclosed for generating the HM, for selective and progressive transmission of the details of a geometric model represented by the HM, and for selectively adding or removing details to or from a desired region of the model. A data structure based on the HM is also disclosed. The HM has a tree of patches of progressively higher levels from a leaf level to a root level. Each patch of one level is merged from respective connected patches of the next lower level. The patches are simplified recursively from the leaf level to the root level, such that the patches of each level represent respective regions of the geometric model at a resolution that is progressively reducing from the leaf level to the root level, for selective and progressive transmission and rendering.

### FIELD OF THE INVENTION

This invention relates generally to using three-dimensional geometric models for computer graphics, and more specifically to techniques for selective progressive transmission and rendering of geometric models.

### BACKGROUND OF THE INVENTION

The popularity of the Internet has brought the development of VRML and Java3D, which enable us to create three-dimensional (3D) virtual environments over the Internet. These 3D distributed applications, however, increase the demand for efficient transmission of 3D models. Some distributed virtual reality (VR) applications (Falby, Zyda, Pratt, & Mackey, 1993; Singh, Serra, Png, & Ng, 1994) even demand real-time on-request transmission of 3D models. They generally employ a standard client-server architecture, in which a central server maintains a geometry database of the virtual environment and distributes object models to clients upon request. Because these object models may be complex and are usually large in number, the network bandwidth often becomes the bottleneck of the system.

There may be two approaches to encoding the object models to reduce the amount of information that must be sent through the network. The first approach is to apply a geometry-compression method to reduce the storage size of the models. Most geometry-compression methods consider the geometry information shared by neighboring polygons and reduce the amount of data needed to represent the polygon mesh (Deering, 1995; Gumhold & Strasser, 1998; Taubin, Gueziec, Horn, & Lazarus, 1998).

The second approach is to encode the object models for progressive transmission. It is to convert the models in such a way that partially transmitted models can be rendered and progressively refined as more information is received. Hence, the client no longer needs to wait for the whole model to be transmitted before rendering, and it can thus provide a more immediate visual feedback to the user. This approach has attracted a lot of attention (Gueziec, Taubin, Lazarus, & Horn, 1998; Hoppe, 1996; Popovic & Hoppe, 1997), and the progressive mesh (Hoppe, 1996) is among the first in this area.

In this type of method, an object model is decomposed into a base mesh and a sequence of progressive records. The base mesh represents the minimum-resolution model of the object. A progressive record stores information of a vertex split that may slightly increase the resolution of the base mesh by introducing two triangles into it. Hence, by applying the sequence of progressive records to the base mesh, the model will gradually increase in resolution until it reaches the highest resolution when all the records have been applied. The resolution of the model can be decreased by reversing the above operation.

To further enhance the performance, selective multi-resolution methods optimize the resolution of an object model for rendering by locally adjusting the resolution of it according to some dynamic information, such as the user's position and line of sight, and the velocity of the object. This dynamic information is referred to as the view and animation parameters. The advantage of dynamically optimizing the model resolution is more obvious for large models. For example, if the user is flying through a large terrain surface, he/she can see only a very small part of the surface most of the time. A selective multi-resolution method can then be used to adjust the resolution of the terrain surface in such a way that the region where the user is looking at has a high resolution while the rest has a lower resolution. This ability to adjust the resolution of a model selectively according to the run-time view and animation parameters implies that the method must be able to operate in real time.

A few selective multi-resolution methods have been developed for managing large terrain models (Falby et al., 1993; Lindstrom et al., 1996; Pajarola, 1998). Basically, these methods regularly subdivide a large terrain surface. A hierarchical data structure, usually in the form of a quadtree, is constructed with the leaf nodes representing individual polygons (that is, the highest resolution) and the root node representing the whole terrain surface (the lowest resolution). Each successive higher level of the tree from the leaf nodes represents a four-time decrease in resolution. With this hierarchical data structure, the resolution of a local region can be adjusted simply by choosing the polygons from higher- or lower-level nodes of the tree for rendering. Although this kind of method usually uses simple data structures and is very efficient, it requires the surface to be regularly subdivided. While this may be fine with a smooth surface, an excessive amount of polygons may need to be created when the surface contains many crests and valleys. As a result, this kind of method may not be suitable for modeling objects of arbitrary topology.

A similar kind of method, but for arbitrary 3-D object models is by subdividing the model into regular 3-D cells (Low & Tan, 1997; Luebke & Erikson, 1997; Rossignac & Borrel, 1993; Schaufler & Sturzlinger, 1995). The cells are then hierarchically combined to form an octree. The resolution of a local region can be reduced by merging (or clustering) multiple cells and vertices within the cells. Although the creation of the octree may be time-consuming (Low & Tan, 1997), the run-time performance of these methods is very high. The major limitation of these methods, however, is that the geometry of the model may not be preserved after the simplification.

Methods that preserve the geometry of the object model are mainly based on edge decimation. Xia, Zl-Sana, and Varshney (1997) used a merge tree to store the edge collapses in a hierarchical manner. To prevent mesh folding, during the construction of the hierarchy, the sequence of edge collapses is constrained to be non-overlapping. As a result, a dependency exists among the nodes in the merge tree. An edge is allowed to split or collapse only if certain neighboring vertices exist. Hoppe (1997) presented the view-dependent progressive mesh similar to Xia et al. (1997) by using a vertex hierarchy, but they differ in that the sequence of edge collapses in Hoppe (1997) is unconstrained and geometrically optimized with minimum dependencies among the collapses. However, because the method requires a model to be transmitted in the form a progressive mesh (Hoppe, 1996), the transmission order must follow a predefined order.

Floriani, Magillo, and Puppo (1998) proposed a method based on a Directed-Acyclic-Graph (DAG) called multi-triangulation (MT). During the simplification or refinement process, a sequence of local operators is applied. Each of them modifies a small region of the mesh, called a fragment. The fragments are arranged into a partial order according to their dependencies and stored in the DAG. At run-time, the resolution of each fragment can be changed independently to produce an adaptive multi-resolution model. In Cignoni, Puppo, and Scopigno (1997), the MT is represented as a simplicial complex in 3D space called hyper-triangulation. The third dimension of it represents the resolution of the fragment, and triangles of different fragments are welded together to form a model. Gueziec et al. (1998) introduced a simpler DAG-based method for progressive model transmission. Surfaces in the model are partitioned during the edge-decimation process, and independent surface patches can be transmitted in the same batch, thus allowing the model to be transmitted progressively to the client. However, because the DAG can be constructed only after the whole model is received, adaptive refinement of different parts of the model is possible only after the client has received the whole model.

Existing methods as discussed above can selectively refine the resolution of an object model. However, due to the neighboring dependency constraints, they may require a large portion or even the complete model to be available at the client before rendering can begin. Support for progressive and selective transmission has not been addressed. In Cignoni et al. (1997), Floriani et al. (1998), and Gueziec et al. (1998), dependency checking in the DAG is needed when retrieving the triangle fragments. In Hoppe (1997, 1998) and Xia et al. (1997), recursive dependency checking of the hierarchy is needed to determine the dependencies among vertices; hence, other parts of the hierarchy need to be presented at the client.

Recently, To et al. (2001) proposed a selective multi-resolution method based on a vertex hierarchy, called vertex tree. During the preprocessing stage, the method simplifies the model by collapsing edges and simultaneously constructing a set of vertex trees to represent the parent-child relationship of the vertices. A vertex fan of each vertex is stored at its node to allow a simple parent-child checking to reduce the dependency among vertices. The root nodes of the vertex trees form the base mesh of the model. At run-time, when a client requests an object model, the server transmits the base mesh nodes of the vertex trees first. Other nodes of the vertex trees will then be transmitted from top to bottom progressively. The server may selectively transmit nodes from different vertex trees according to the view and animation parameters of the client at the time of the transmission. However, an extra vertex dependency check is needed to perform at the server before a node may be transmitted. This is done by checking the vertices of the vertex fan in the node. If certain vertices in the vertex fan are not available at the client, the server needs to trace up the corresponding vertex trees and replacing these vertices with their first visible parents.

The present invention seek to mitigate or at least alleviate the above problems by providing methods and apparatus for storing, transmitting and rendering of 3D models using a new hierarchical data structure, referred herein as the Hierarchical Mesh (HM). Unlike existing methods, the new method eliminates the neighboring dependency constraint to support progressive and selective model transmission. Hence, the server may only transmit selected parts of a model to a client. This ability of selective transmission allows the visualization of very large geometric models across the network with minimal delay.

### OBJECTS AND ADVANTAGES OF THE INVENTION

It is the first object and advantage of this invention to provide a data structure for representing a geometric model for selective progressive transmission and rendering.

It is another object and advantage of this invention to provide a method for selective and progressive transmission of the details of a geometric model from one machine/device to another one via a typical data communication channel. In general, the sender and receiver machine/device may physically be the same or separated machine(s)/device(s).

It is another object and advantage of this invention to provide a method for enabling the selection of all optimal resolution of a geometric model while preserving most of the details of the important parts of the model to meet the budget limits or other constraints of the user's applications.

It is another object and advantage of this invention to allow visually important parts of a geometric model to be transmitted to the client at higher priority than the less important parts and progressively reconstructed there for display. The ability of performing selective multi-resolution modeling with partially transmitted models will be useful in the visualization of large and detailed geometric models or in the walkthrough of a distributed virtual environment over networks.

### SUMMARY OF THE INVENTION

The foregoing and other problems are overcome and the objects and advantages are realized by the methods and apparatus in accordance with this invention.

An aspect of this invention is a novel representation for selective progressive transmission and rendering of a geometric model, referred to herein as a Hierarchical Mesh (HM). Methods are disclosed for selectively and progressively constructing a geometric model from the HM. In accordance with a further aspect of this invention, methods are disclosed for generating the HM.

Another aspect of this invention provides a method for selective and progressive transmission of the details of a geometric model. After the HM has been constructed from a geometric model, the details of the geometric model may be selectively and progressively transmitted from one machine/device, which stores the HM of the geometric model, to another one via a typical data communication channel. In general, the sender and receiver machine/device may physically be the same or separate machine(s)/device(s). The receiver machine/device may then selectively and progressively reconstruct the geometric model based on the details of the geometric model received. In accordance with a further aspect of this invention, methods are disclosed for transmitting geometric models using the HM representation.

Another aspect of this invention provides a method for selectively adding or removing details from any desired region of a geometric model. Typically, with the HM representation, it is possible to choose details from the unimportant part of the geometric model to be removed, and preserve details from the important part of the geometric model as much as possible. This helps to produce a representation of the geometric model in an optimal resolution, to meet the budget limits or other constraints of the user's applications.

According to a first aspect of the invention, there is provided a method of generating a hierarchical mesh for a geometric model for transmission, the geometric model comprising a plurality of connected triangular faces comprising vertices, edges and wedges, which method comprises the steps of:

(a) merging the faces into a set of patches of a leaf level;

(b) merging the resulting patches into a set of patches of a higher level;

(c) repeating step (b) recursively from one level to a higher level until all the patches are merged into at least one root patch of a root level; and

(d) simplifying the patches recursively from the leaf level to the root level, such that the patches of each level represent respective regions of the geometric model at a resolution that is progressively reducing from the leaf level to the root level for selective and progressive transmission.

Preferably, step (d) is performed after completion of step (c) and recursively from the leaf level to the root level.

It is preferred that the patches of the leaf level comprise respective disjointed groups of connected faces.

Preferably, the patches of each level other than the leaf and root levels comprise respective disjointed groups of connected patches.

It is preferred that step (c) results in the formation of a single root patch at the root level.

In a preferred embodiment, step (a) comprises the steps of:

(a1) selecting a set of faces, with each selected face being located at least a minimum distance apart from each of the other selected faces;

(a2) for each selected face, selecting a neighboring face that has the closest similarity in orientation and then merging it therewith to form a patch; and

(a3) repeating step (a2) for each patch until the resulting patch reaches or exceeds one of predetermined size limit and predetermined radius limit.

Preferably, step (b) comprises the steps of:

(b1) selecting a set of patches, with each selected patch being located at least a minimum distance apart from each of the other selected patches;

(b2) for each selected patch, selecting a neighboring patch that has the closest similarity in orientation and then merging it therewith to form a new patch; and

(b3) repeating step (b2) for each patch until the resulting patch reaches or exceeds one of predetermined size limit and predetermined radius limit.

It is preferred that step (d) comprises the steps of:

(d1) performing a series of edge collapse operations on the patches of the leaf level individually until each patch reaches a predetermined minimal resolution; and

(d2) repeating step (d1) for the patches of the next higher level and recursively until all the patches in the hierarchical mesh are simplified.

It is further preferred that each patch has a boundary including a plurality of vertices, and the edges joined to the boundary vertices are excluded from the edge collapse operations.

It is further preferred that the edge collapse operations are performed on the edges in a sequence chosen to minimise distortion of the simplified patches compared with the corresponding original patches.

It is further preferred that the simplified patches of each level have respective predetermined minimal resolutions prior to patch simplification at the next higher level.

It is further preferred that step (d1) includes constructing an ordered list of refinement records storing information indicating how respective edges of each patch are collapsed, which is useful for rendering the patch from one level to another.

It is yet further preferred that each refinement record comprises information relating to the two vertices of a corresponding collapsing edge, its two adjacent faces and the affected wedges.

According to a second aspect of the invention, there is provided a method of selective and progressive transmission of details of a geometric model represented by the hierarchical mesh generated according to the aforesaid method to a receiver, comprising the steps of:

(A) selecting and transmitting a base mesh of the hierarchical mesh, the base mesh comprising the simplified root patch;

(B) determining at least one dynamic parameter relative to said receiver; and

(C) selecting and transmitting visible patches of the hierarchical mesh meeting the dynamic parameter, together with the associated refinement records for rendering the visible patches individually through a series of vertex split operations at said receiver for an optimal resolution.

Preferably, the dynamic parameter comprises an application or user specific run-time condition comprising virtual distance of the geometric model relative to said receiver.

Preferably, the dynamic parameter comprises an application or user specific run-time condition comprising moving velocity of the geometric model relative to said receiver.

Preferably, the dynamic parameter comprises an application or user specific run-time condition comprising angular distance of the geometric model from said receiver's line of sight.

Preferably, step (C) includes transmitting patches of intermediate levels between the base mesh and the visible patches progressively from one level to a lower level, together with the associated refinement records for transitional rendering at increasing resolution.

According to a third aspect of the invention, there is provided a method of selectively adding or removing details to or from a desired region of a geometric model represented by the hierarchical mesh generated according to the aforesaid method, comprising steps of:

(I) representing the geometric model by rendering selected patches of the hierarchical mesh, the patches representing unique regions of the geometric model including the desired region;

(II) performing a patch split operation on the patch representing the desired region by replacing the patch with patches representing the same region at the next lower level, whereby details are added to the desired region; or

(III) performing a patch collapse operation on the patch representing the desired region and neighboring patch or patches of the same level by replacing such patches with a patch of the next higher level, whereby details are removed from the desired region.

Preferably, the patch collapse operation of step (III) comprises a series of edge collapse operations.

Preferably, the patch split operation of step (II) comprises a series of vertex split operations.

According to a fourth aspect of the invention, there is provided a data structure based on the hierarchical mesh generated according to the aforesaid method for representing a geometric model comprising a plurality of connected triangular faces, for selective and progressive transmission and rendering, which data structure comprises:

a tree of patches of progressively higher levels from a leaf level to a root level, each patch of each level other than the leaf level being a union of respective connected patches of the next lower level, the patches being simplified recursively from the leaf level to the root level, such that the patches of each level represent respective regions of the geometric model at a resolution that is progressively reducing from the leaf level to the root level.

a base mesh comprising at least one simplified root patch of the root level; and

a tree of refinement lists storing information indicating how the patches are simplified.

Preferably, the patches are arranged in a parent-child manner as the tree of patches, with child patches of one level united into a corresponding parent patch of the next higher level.

Preferably, each refinement list comprises a list of refinement records for an associated patch, storing information indicating how its edges are collapsed in a series of operations for patch simplification.

### BRIEF DESCRIPTION OF DRAWINGS

The invention will now be more particularly described, by way of example only, with reference to the accompanying drawings, in which:

FIGS. 1(a) to 1(i) show the images of a test geometric model rendered by an embodiment of a method in accordance with the invention;

FIG. 2 is a block diagram showing the data structure of a hierarchical mesh for a geometric model rendered by the method;

FIG. 3 is a flow diagram illustrating the construction of the hierarchical mesh of FIG. 2;

FIG. 4 is a flow diagram illustrating simplification of the hierarchical mesh of FIG. 2;

FIG. 5 is a flow diagram illustrating transmission of the geometric model of FIG. 2; and

FIG. 6 is a flow diagram illustrating rendering of the geometric model of FIG. 2.

### DETAILED DESCRIPTION OF PREFERRED EMBODIMENT

Overview of 3D Geometric Models

The input according to this invention is a 3D geometric model, which is a data structure that consists of a list of vertices, a list of edges, a list of wedges, a list of faces and a list of material properties. A vertex represents a point in the 3D space, which has a coordinate in XYZ directions. An edge is a line joining two vertices together There should be at most two faces connected to each edge. A wedge is an intermediate abstraction layer between vertices and faces, which is used to encapsulate the scalar attributes, such as normal vectors and texture coordinates, of a vertex. A face is a triangular plane with exactly three wedges at its corners. Material attributes represent the discrete attributes, such as ambient, diffuse, emissive, specular and shininess, of the faces, which are used to specify the appearance of the faces in rendering.

Construction of Hierarchical Mesh (HM)

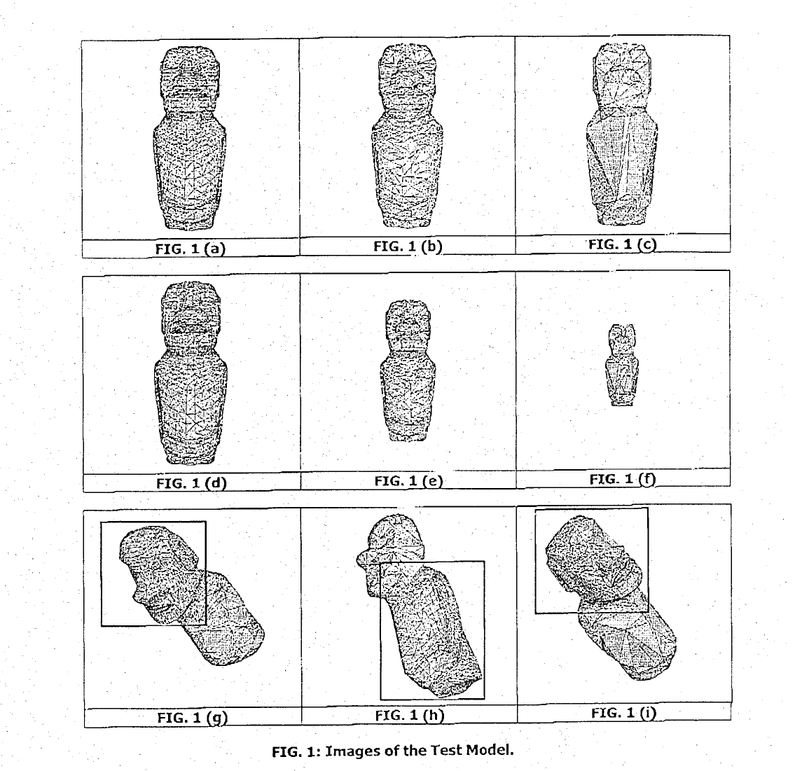

To facilitate the selective transmission of a geometric model, a Hierarchical Mesh (HM) is constructed from an input geometric model. FIGS. 1(a) to 1(i) show the images of a test model rendered according to the invention, as displayed on a monitor screen.

FIG. 1(a) shows the test model constructed by 4,976 polygons, and FIGS. 1(b) and 1(c) show the test model simplified to 2,470 and 336 polygons respectively, all being of the same size as displayed. FIGS. 1(d) to 1(f) depict the same models of FIGS. 1(a) to 1(c) respectively, but displayed in reducing sizes to show that they are located at increasing object distances away from the viewer. The nearest image of FIG. 1(d) is displayed in a relatively high resolution for showing its detailed features. The farthest image of FIG. 1(f) is displayed in a relatively low resolution, for saving in data transmission or graphic rendering speed, etc. to meet the budget limits or other constraints of the application.

FIGS. 1(g) to 1(i) show selective refinements of the images of the test model viewed at different angles, rendered using 2,472, 1,846 and 2,212 polygons respectively. The three rectangles in FIGS. 1(g) to 1(i) represent corresponding regions of the model of interest to the viewer, which are closest to the viewer and thus rendered at a higher (maximum) resolution as necessary. The rest of the images are rendered at a lower resolution, likewise to meet the budget limits or other constraints of the application.

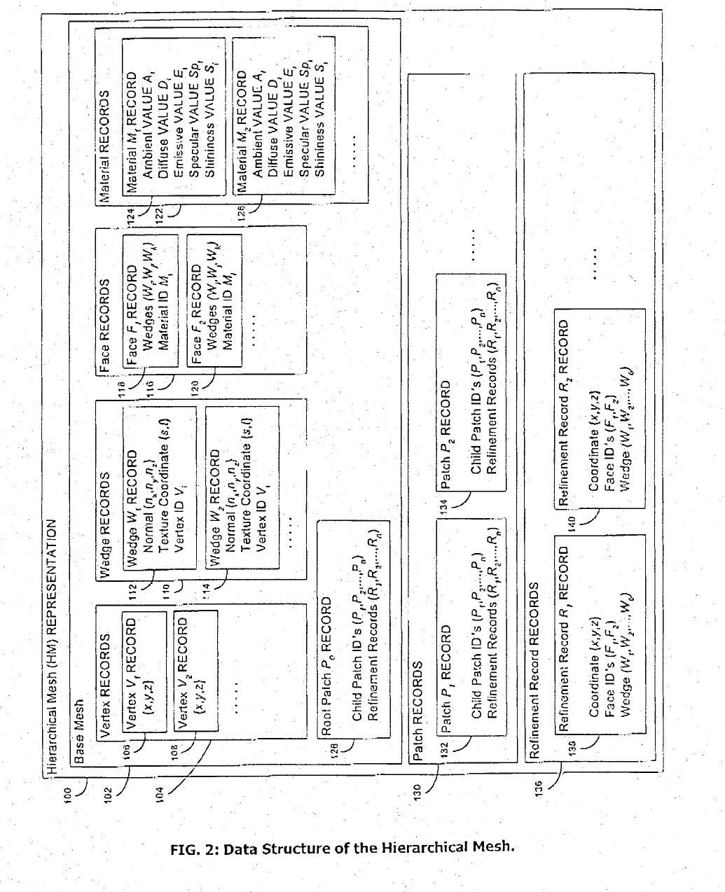

FIG. 2 depicts the data structure 100 for the HM. The data structure 100 includes data structures for a base mesh 102, a set of patches 130 and a set of refinement records 136. The base mesh 102 is composed of a set of vertices 104, a set of wedges 110, a set of faces 116, a set of materials 122 and a root patch 128. The data structures 132-134 show the information contained in the patches. The data structures 138-140 show the information contained in the refinement records. Moreover, the data structures 106-108, 112-114, 118-120 and 124-126 show the information contained in the vertices, wedges, faces and materials, respectively.

To construct a HM, a set of patches is constructed by grouping the faces of the input geometric model. Such patches are then merged to form super-patches, and this merging process will be performed recursively on the super-patches until all patches are implicitly merged into a single super-patch. This single super-patch then becomes the root patch of the HM.

Construction of Patches

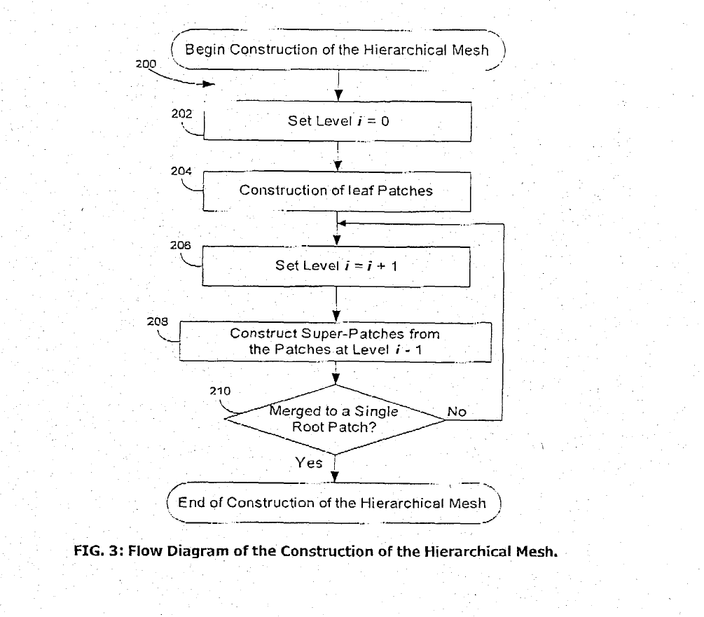

FIG. 3 depicts how to construct a HM. In step 200, the geometric model is inputted to the HM construction operation. In step 202, the current level of the HM is set to 0, i.e. the lowest or leaf level of the HM. In step 204, the set of leaf patches of the HM is constructed. The detail of constructing the leaf patches is described as follows.

A patch Pₗ⁰ is constructed by a set of connected faces {F₁,F₂, . . . ,Fₙ} with similar orientation, i.e. those lying on or closer to the same imaginary plane. The upper index of P, which is referred to as the level index, indicates that the patch is located at level 0, i.e. the leaf level of the HM. The lower index of P, which is referred to as the patch index, uniquely identifies the patch from the other patches at the same level of the HM. Each face Fᵢ of a patch Pᵢ⁰ consists of at least one edge which is a shared edge of face Fᵢ and another face Fⱼ of the patch Pₗ⁰. Mathematically, a patch Pᵢ⁰ is defined as the union of a set of connected faces, i.e. Pₗ⁰=F₁ θ F₂ θ . . . θ Fₙ. In addition, each set of faces constructing a patch is disjoint to, or does not overlap with, any other set of faces that constructs another patch of the same geometric model.

During the preprocessing stage, each group of connected faces of the geometric model is assigned to form an individual patch. One possible way to construct a patch is first to randomly select a set of faces {F₁, F₂, . . . Fₙ} from the geometric model, in which each face is located at least a minimum distance apart from each of the other selected faces. These selected faces are assigned as a set of individual patches {P₁⁰,P₂⁰, . . . ,Pₙ⁰}. Then, for each of these patches, Pᵢ⁰, a merging process is carried out. The process selects a neighboring face Fᵢ, which has the closest similarity in orientation with Pᵢ⁰, to merge with Pᵢ⁰ to form a new patch. This new patch replaces the original patch Pᵢ⁰, and is referred to as Pₗ⁰. The same merging process is performed repeatedly on each patch Pᵢ⁰ until the size of a patch reaches and/or exceeds a predetermined patch size limit or a predetermined patch radius limit. Alternative methods may be employed to construct patches as long as they may group connected faces with similar orientation to form patches. The output of the patch construction process is a set of patches {P₁⁰,P₂⁰, . . . ,Pₙ⁰}, in which each patch represents a disjointed, unique region of the geometric model.

Construction of Super-Patches

After constructing the leaf level patches of the HM of the geometric model, in step 206, the current level of the HM is increased by 1. In step 208, the super-patches are constructed from the patches. The set of super-patches is constructed in a similar way as constructing the patches, and they will form a new level of the HM. For example, a super-patch Pᵢ^{L} is constructed from a set of connected patches {P₁⁰,P₂⁰, . . . ,Pₙ⁰} with similar orientation, where the level index of the super-patch is set to as the current level of the HM, i.e. L=1. After constructing the super-patches from the leaf patches, we have a set of super-patches {P₁¹,P₂¹, . . . ,P₂¹}, where each of the super-patches is defined as Pᵢ¹=P₁⁰ θ P₂⁰ θ . . . θ Pₙ⁰ and w<n. In addition, each patch Pᵢ⁰ of a super-patch Pᵢ¹ is adjacently connected to at least one other patch of the same level of the HM. Moreover, within the same level, each set of patches constructing a super-patch is disjoint to any other set of patches that constructs another super-patch. Each of the resultant super-patches again represents a disjointed, unique region of the geometric model, which is the union of the regions represented by the patches constructing the super-patch.

Step 210 checks if all patches are implicitly merged to a single patch P₀^{R}, where R is the highest or root level of the HM. If this is the case, the HM construction process will terminate for the input geometric model. Otherwise, the method loops back to step 206 to increase the current level of the HM by 1. In step 208, the set of super-patches from the previous level, i.e. L−1, will act as the input patches for constructing another new level of super-patches for the HM. This operation will be carried out recursively until all patches are implicitly merged to the root patch P₀^{R}, where R is the root level of the HM. Finally, a hierarchy of patches is constructed, where each patch in the HM may be represented as Pᵢ^{m+1}=P₁^{m} θ P₂^{m} θ . . . θ Pₙ^{m}. Within the HM, Pᵢ^{m+1} is the parent of Pⱼ^{m}ε{P₁^{m},P₂^{m}, . . . ,Pₙ^{m}}, and each patch within the set of patches {P₁^{m},P₂^{m}, . . . ,Pₙ^{m}} is a child of Pᵢ^{m+1}.

During the run-time stage, if a region of the geometric model is currently represented by Pᵢ^{m+1}, and the representation of this region is replaced by the set of child patches of Pᵢ^{m+1}, i.e. {P₁^{m},P₂^{m}, . . . ,Pₙ^{m}}. Such operation is referred to as a patch split. In contrast, if the set of child patches {P₁^{m},P₂^{m}, . . . ,Pₙ^{m}} are replaced by their parent patch Pᵢ^{m+1}, such operation is referred to as a patch collapse.

To implement the super-patch construction process, one possible way is to generalize the face merging process used in constructing the leaf patches as described above. Initially, a set of patches {P₁^{m},P₂^{m}, . . . ,Pₙ^{m}} is randomly selected, in which each patch is located at least a minimum distance apart from each of the other selected patches. These selected patches are assigned as a set of individual super-patches {P₁^{m+1},P₂^{m+1}, . . . ,Pₙ^{m+1}}. Then, for each of these super-patches, Pᵢ^{m+1}, a merging process is carried out. The process selects a neighboring patch of Pₗ^{m+1}, which has the closest similarity in orientation with Pₗ^{m+1}, to merge with Pᵢ^{m+1} to form a new super-patch. This new patch replaces the original patch Pᵢ^{m+1}, and is referred to as Pᵢ^{m+1}. The same merging process is performed repeatedly on each super-patch Pᵢ^{m+1} until the size of a super-patch reaches or exceeds a predetermined super-patch size limit and/or a predetermined super-patch radius limit. Alternative methods may be employed to construct super-patches as long as they may group patches with similar orientation to form super-patches.

Simplification of the Hierarchical Mesh

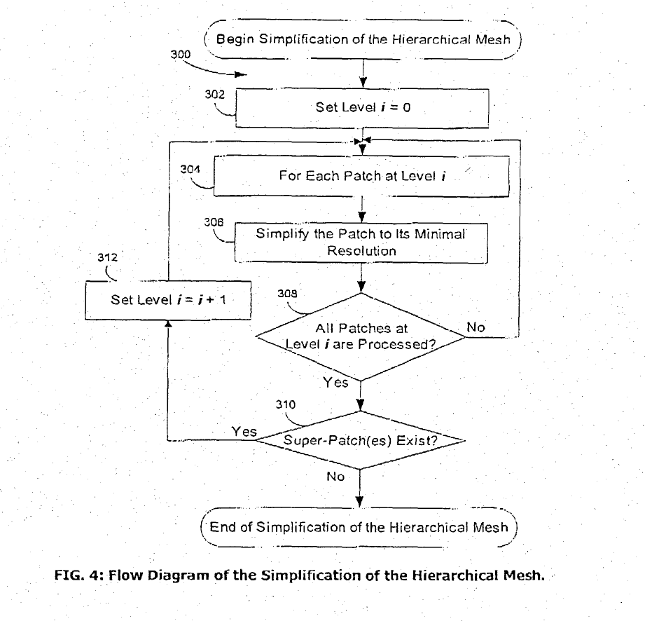

After constructing a HM from the input geometric model, a hierarchical mesh simplification operation is performed on the HM. FIG. 4 depicts the method of HM simplification. In step 300, the HM is inputted to the HM simplification process. This process contains a set of recursive patch simplification operations, in which each is a series of edge collapses performed on a patch to produce an ordered list of refinement records. The output of the hierarchical mesh simplification process is a base mesh and a tree of refinement lists.

Patch Simplification

Patch simplification contains a series of edge collapse operations performed on a patch. Each edge collapse operation collapses an edge (vₐ,v_{b}) to a single vertex v_{new}. To avoid the creation of new vertices during simplification, it is preferred to choose vₐ or v_{b} as v_{new} for each edge collapse operation. The edge collapse operation causes the removal of the edge (vₐ,v_{b}) as well as the triangles attaching to that edge from the patch. The inverse operation of an edge collapse is a vertex split, which adds the edge (vₐ,v_{b}) and the triangles adjacent to the edge back to the patch. Thus, the edge collapse operation simplifies a patch and the vertex split operation adds details to the patch. The particular sequence of edge collapse operations must be chosen carefully, since it determines the quality of the simplified patches after each edge collapse operation.

To implement the patch simplification process, one possible way is to employ the progressive mesh method (Hoppe, 1996) to perform edge collapse operations on the patches in the HM. The method provides an energy function to measure the accuracy of the simplified patch with respect to the original patch. Such energy function helps to arrange the sequence of edge collapse operations according to how each edge collapse operation affects the energy function. Another possible method to arrange the sequence of edge collapse operations is to employ the error quadrics as described in (Garland, 1997). A good sequence of edge collapse operations minimizes the distortion between the patches before and after edge collapse, for each edge collapse operation. Thus, in general, the edge collapse operations are performed on the edges in a sequence chosen to minimise distortion of the simplified patches compared with the corresponding original patches.

Each patch has a boundary including a plurality of vertices, and boundary vertices are those vertices located at the boundary of the patch concerned. One additional constraint in performing the edge collapse operations is disallowing the boundary vertices of the patch to collapse to other vertices or boundary vertices. In other words, the edges joined to the boundary vertices are excluded from the edge collapse operations. This avoids cracks to be appeared between adjacent patches.

During each edge collapse operation, an edge is selected as the input to the operation, and a refinement record rᵢ, will be constructed to store the information describing how the edge is collapsed. When an edge is selected to collapse, the two attached faces of the edge, the wedges and vertices that are connected to these two faces will be identified. Such information will be stored in the corresponding refinement record. The refinement record consists of several fields, including the vertex identifications of the two ending vertices of the collapsing edge, the face identifications of the two adjacent faces, and the wedge identifications of the affected wedges. At the same time, the corresponding identifications within the edges, wedges, faces and patches will be updated accordingly. In addition, the attributes of the mesh will be updated accordingly. Typically, the normal vectors of the surrounding faces will be re-calculated using the new vertex coordinate values.

To simplify a patch Pᵢ^{m} in the HM, the edge collapse process will be iterated to remove details from the patch, until the patch reaches its minimum resolution. Finally, an ordered list of refinement records {r₁,r₂, . . . ,rₙ} is obtained from the patch simplification process. This list is referred to as a refinement list Lᵢ^{m}, which is uniquely associated with the patch Pᵢ^{m}.

Hierarchical Mesh Simplification

A patch simplification operation may only simplify a region of the geometric model. To simplify the whole geometric model, a series of patch simplification operations are performed recursively on the HM of the geometric model. To do this, in step 302, the current level of the HM is set to is 0, i.e. the leaf level of the HM. In step 304, the patches at the current level are retrieved one by one. In step 306, each of these patches is simplified to a respective predetermined minimal resolution, which is preferably uniform across the entire patch. Step 308 checks if all patches in the current level are processed. If this is not the case, the method loops back to step 304 to perform simplification on another patch at the current level. Otherwise, step 310 checks if super-patches exist. If they do, step 312 advances the current level by 1 and loops, back to step 304 to perform simplification on the super-patches. Otherwise, the HM simplification process will be ended. The detail of the HM simplification process is described as follows.

Starting from the leaf patches {P₁⁰,P₂⁰, . . . ,Pₙ⁰} of the HM, for each patch Pᵢ⁰, a series of edge collapse operations are performed on the patch to reduce the resolution of the patch to the minimal. Consequently, a refinement list Lᵢ⁰ is generated for the patch. After performing the patch simplification operations on the leaf patches of the HM, the resolution of the geometric model is reduced to a certain extent. To further reduce the resolution of the geometric model, a new set of patch simplification operations is performed on the super-patches of the leaf patches. As the input to the new patch simplification operations, each of these super-patches is the union of its child patches, in which each of them is in its minimal resolution. After the patch simplification operations, a separate refinement list is generated for each super-patch. These super-patches will have been simplified to their minimum resolution. Such patch simplification operations are performed recursively on the HM, until the root patch is simplified to its minimal resolution.

Such recursive operations reduce the resolution of the geometric model to the minimal. Ultimately, a base mesh and a tree of refinement lists are obtained. The base mesh is the simplified root patch of the HM, which is the least displayable part of the geometric model. The tree of refinement lists is used in selective refinement and transmission of the geometric model.

As a result of the recursive patch simplification operations, the patches and super-patches, or the child and parent patches, are reduced to gradually reducing minimal resolutions, whereby quantization of patch resolution is implemented for selective and progressive processing.

Model Transmission and Rendering

According to this invention, the geometric models are progressively and selectively transmitted with the HM from one machine/device to another one via a typical data communication channel. Typically, the sender machine/device may be referred to as the server, and the receiver machine/device may be referred to as the client. When a client requests a model, the server will first transmit the base mesh followed by a sequence of refinement records. The order of transmission of the refinement records is determined at run-time based on their pre-determined order within a patch and current visible patches of the geometric model. The current visible patches are determined from the view and animation parameters, or dynamic parameters, based on or according to the application or user specific run-time condition. Examples of such run-time conditions are, particularly but not exclusively, the virtual distance of the model relative to the client or a viewer the moving velocity of the model relative to the viewer, the angular distance of the model from the viewer's line of sight, and the current system frame rate of the client.

At run-time, the server determines the visible patches of each geometric model and appropriate refinement records for transmission to the client. The client reconstructs the geometric model based on the information supplied by the server and determines the appropriate resolution of each geometric model or its regions, as illustrated and described in relation to FIGS. 1(d) to 1(i), to meet the budget limits or other constraints of the application. Typically, a client may receive the geometric models for rendering, but it is not necessary to restrict the application to such a purpose.

The Server Process

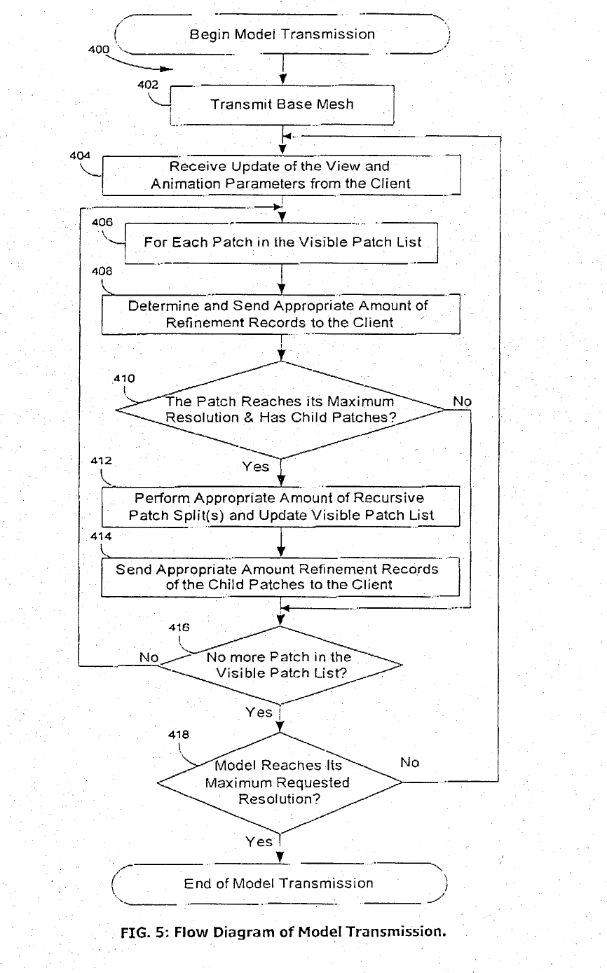

FIG. 5 depicts the method of transmitting a geometric model represented as a HM. At the server, a HM is constructed for each geometric model in advance, which is used as the input to step 400. For each model, a visible patch list is maintained for each client to allow quick determination of refinement records to send to the client. The list links up the current visible patches of the HM for the client requesting the model. At the beginning of transmitting the model, the visible patch list contains only a reference to the base mesh, i.e. the root patch P₀^{R} of the HM. In step 402, the base mesh is then transmitted to the client.

In step 404, the server receives updates of the current view and animation parameters from the client, which may include information such as the object distance from the viewer, the object moving velocity and the current system frame rate of the client. Such parameters indicate how important of a model or certain part of a model is to the client. After receiving these parameters from the client, in step 406, the server processes each patch Pᵢ^{m} referenced in the visible patch list based on these parameters to determine the importance of Pᵢ^{m} to the clients. In step 408, if it is determined that the client needs more details on Pᵢ^{m}, an appropriate amount of refinement records associating with Pᵢ^{m} will be sent to the client to refine its own copy of the model; otherwise, no action will be taken.

On the other hand, step 410 checks if Pᵢ^{m} has reached its maximum resolution and its child patches {P₁^{m+1},P₂^{m+1}, . . . ,Pₙ^{m+1}} exist. If both of then are true, step 412 performs an appropriate amount of recursive patch split operation(s) on Pᵢ^{m}. As a result, the entry of the reference of Pᵢ^{m} in the visible patch list will be replaced by the references of {P₁^{m+1},P₂^{m+1}, . . . ,Pₙ^{m+1}}. At the same time, in step 414, an appropriate amount of refinement records from these child patches will also be transmitted to the client based on the view and animation parameters. In step 416, if there are still patches in the visible patch list not yet processed, the method loops back to step 406 to process another patch. Otherwise, step 418 checks if the maximum requested resolution of the model has already been transmitted to the client. If this is the case, the transmission process for the requested geometric model will be terminated. Otherwise, the above process will be iterated until either the appropriate amount of details of the model are sent to the client or the maximum resolution of the model is reached, i.e. all the details of the model are sent to the client.

The Client Process

At the client, the HM of a geometric model is being reconstructed as the refinement records are received. In addition, a visible patch list is maintained to allow quick determination of the resolution of the model. The list indicates the current visible patches and is constantly being updated as more refinement records are received at the client or the view and animation parameters of the client are being changed.

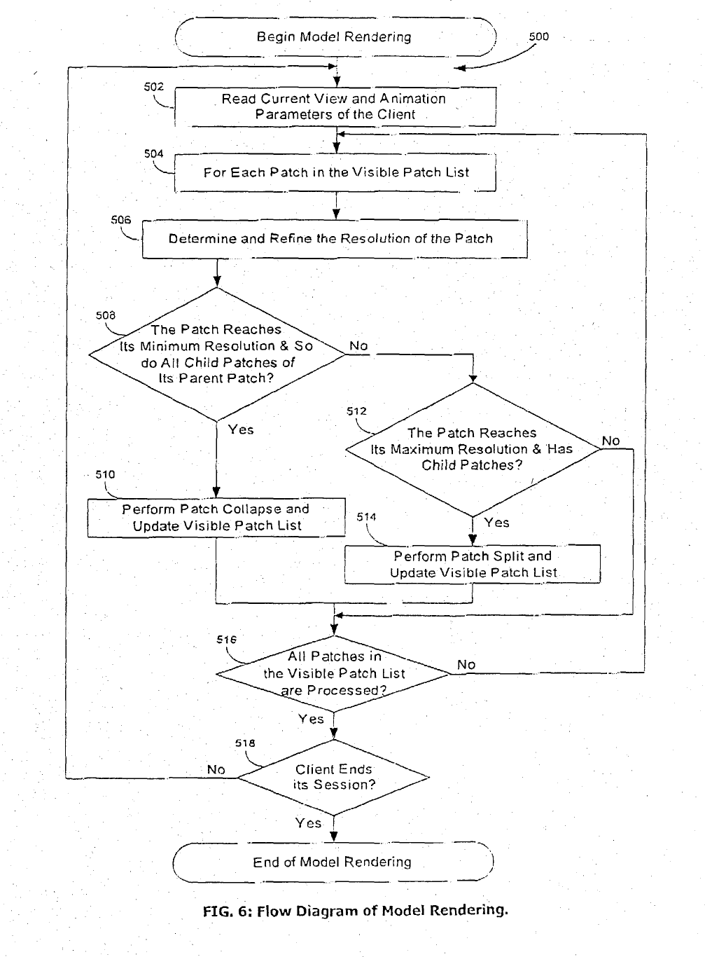

FIG. 6 depicts the method for rendering the model using the HM representation. At the client, the received base mesh of the model is the input to step 500. In step 502, the method reads the current view and animation parameters of the client. In step 504, the client traverses each patch in the visible patch list. In step 506, each patch Pₗ^{m} referenced in the list is processed against the current view and animation parameters of the client to determine the importance of Pᵢ^{m} to the client. If the importance of Pᵢ^{m} is found to be lower, its resolution will be reduced through executing a series of edge collapse operations on the patch. In step 508, if Pₗ^{m} has reached its minimum resolution and Pᵢ^{m} is not the root patch, all the child patches of its parent patch are checked to determine if they are all refined to their minimum resolutions. If they are, step 510 performs a patch collapse operation on these child patches. As a result, the visible patch list will be updated to exclude all references to these child patches and include the reference of their parent patch.

On the other hand, if the importance of Pᵢ^{m} is found to be higher, its resolution will be increased through executing a series of vertex split operations on the patch. In step 512, if Pᵢ^{m} reaches its maximum resolution and Pᵢ^{m} is not a leaf node, a patch split operation is performed on Pᵢ^{m} as in step 514. As a result, the visible patch list will be updated to exclude the reference of Pᵢ^{m} and include the references of the child patches of Pᵢ^{m}. In step 516, if there are still patches in the visible patch list not yet processed, the method loops back to step 504 to process the next patch. After the process, the model will be refined to an optimal resolution and triangles are retrieved from the patches referred in the visible patch list to form a triangle list for display. Step 518 determines if the client ends its session on rendering the model. If this is the case, the rendering of the model will be terminated. Otherwise, the method loops back to step 502 to continue the model rendering process.

Having described and illustrated the principles of the subject invention with reference to the given embodiment, it will be recognized that various modifications of and/or alterations in arrangement and detail to the described embodiment may be made by persons skilled in the art without departing from the scope of the invention as specified in the appended claims.

It should be understood that the operations, processes or methods described herein are not related or looted to any particular type of machines/devices, unless indicated otherwise. Various types of general purpose or specialized machines/devices may be used with or perform operations in accordance with the teachings described herein. Elements of the illustrated embodiment may be implemented in software or hardware.

In view of the many possible embodiments to which the principles of the subject invention may be applied, it should be recognized that the detailed embodiments are illustrative only and should not be taken as limiting the scope of the invention. Rather, the invention encompasses all such embodiments as may come within the scope and spirit of the following claims and equivalents thereto.

Reference

Chim, J., Green, M., Lau, R. W. H., Leong, H. V., & Si, A. (1998). On caching and prefetching of virtual objects in distributed virtual environments. Proceedings of ACM Multimedia (pp. 171-180).

Clim, J., Lau, R. W. H., Leong, H. V., & Si, A. (2003). CyberWalk: A Web-based Distributed Virtual Walkthrough Environment IEEE Transactions on Multimedia (To appear).

Cignoni, P., Puppo, E., & Scopigno, R. (1997). Representation and visualization of terrain surfaces at variable resolution. The Visual Computer, 13(5), 199-217.

Deering, D. (1995). Geometry compression. Proceedings of ACM SIGGRAPH'95 (pp. 13-20).

Falby, J., Zyda, M., Pratt, D., & Mackey, R. (1993). NPSNET: Hierarchical data structures for real-time threedimensional visual simulation. Computers & Graphics, 17(1), 65-69.

Floriani, L., Magillo, P., & Puppo, E. (1998). Efficient implementation of multi-triangulation. Proceedings of IEEE Visualization (pp. 43-50).

Garland, M. & Heckbert, P. (1997). Surface Simplification Using Quadric Error Metrics. Proceedings of ACM SIGGRAPH'97 (pp. 209-216).

Gueziec, A., Taubin, G., Lazarus, F., & Horn, W. (1998). Simplical maps for progressive transmission of polygonal surfaces. Proceedings of Symposium on VRML'98 (pp. 25-31).

Gunhold, S., & Strasser, W. (1998). Real-time compression of triangle mesh connectivity. Proceedings of ACM SIGGRAPH' 98 (pp. 133-140).

Hoppe, H. (1996). Progressive meshes. Proceedings of ACM SIGGRAPH'96 (pp. 99-108).

Hoppe, H. (1997). View-dependent refinement of progressive meshes. Proceedings of ACM SIGGRAPH'97 (pp. 189-198).

Hoppe, H. (1998). View-dependent level-of-detail control and its application to terrain rendering. Proceedings of IEEE Visualization'98 (pp. 35-42).

Lau, R. W. H., Green, M., To, D., & Wong, J. (1998). Realtime continuous multi-resolution method for models of arbitrary topology. Presence: Teleoperators and Virtual Environments, 7(1), 22-35.

Lindstrom, P., Koller, D., Ribarsky, W., Hodges, L., Faust, N., & Turner, G. (1996). Real-time continuous level of detail rendering of height elds. Proceedings of ACM SIGGRAPH'96 (pp. 109-118).

Low, K., & Tan, T. (1997). Model simplification using vertex clustering. Proceedings of ACM Symposium on Interactive 3D Graphics (p. 75-81).

Luebke, D., Erikson, C. (1997). View-dependent simplification of arbitrary polygonal environments. Proceedings of ACM SIGGRAPH'97 (pp. 199-208).

Pajarola, R. (1998). Large-scale terrain visualization using the restricted quadtree triangulation. Proceedings of IEEE Visualization'98 (pp. 19-26).

Popovic, J., & Hoppe, H. (1997). Progressive simplicial complexes. Proceedings of ACM SIGGRAPH'97 (pp. 209-216). Rossignac, J., & Borrel, P. (1993). Multi-resolution 3D approximations for Rendering. Modeling in Computer Graphics (pp. 455-465). New York: Springer-Verlag.

Schaufler, G., & Sturzlinger, W. (1995). Generating multiple levels of detail for polygonal geometry models. Proceedings of Eurographics Workshop on Virtual Environments (pp. 31-41).

Singh, G., Serra, L., Png, W., & Ng, H. (1994). BrickNet: A software toolkit for network-based virtual worlds. Presence: Teleoperators and Virtual Einvironments, 3(1), 19-34.

Taubin, G., Gueziec, A., Horn, W., & Lazarus, F. (1998). Progressive forest split compression. Proceedings of ACM SIGGRAPH'98 (pp. 123-132).

To, D., Lau, R. W. H., & Green, M. (2001). An Adaptive Multi-Resolution Method for Progressive Model Transmission. Presence: Teleoperators and Virtual Environments, 10(1), 62-74.

Xia, J., El-Sana, J., & Varshney, A. (1997). Adaptive real-time level-of-detail-based rendering for polygonal models. IEEE Transaction of Visualization and Computer Graphics, 3(2),171-183.

What we claim is:

1. A method of generating a hierarchical mesh for a geometric model for transmission, the geometric model comprising a plurality of connected triangular faces comprising vertices, edges and wedges, which method comprises the steps of:
(a) merging the faces into a set of patches of a leaf level;
(b) merging the resulting patches into a set of patches of a higher level;
(c) repeating step (b) recursively from one level to a higher level until all the patches are merged into at least one root patch of a root level; and
(d) simplifying the patches recursively from the leaf level to the root level, such that the patches of each level represent respective regions of the geometric model at a resolution that is progressively reducing from the leaf level to the root level for selective and progressive transmission.

2. The method as claimed in claim 1, wherein step (d) is performed after completion of step (c) and recursively from the leaf level to the root level.

3. The method as claimed in claim 1, wherein the patches of the leaf level comprise respective disjointed groups of connected faces.

4. The method as claimed in claim 1, wherein the patches of each level other than the leaf and root levels comprise respective disjointed groups of connected patches.

5. The method as claimed in claim 1, wherein step (c) results in the formation of a single root patch at the root level.

6. The method as claimed in claim 1, wherein step (a) comprises the steps of:
(a1) selecting a set of faces, with each selected face being located at least a minimum distance apart from each of the other selected faces;
(a2) for each selected face, selecting a neighboring face that has the closest similarity in orientation and then merging it therewith to form a patch; and
(a3) repeating step (a2) for each patch until the resulting patch reaches or exceeds one of predetermined size limit and predetermined radius limit.

7. The method as claimed in claim 1, wherein step (b) comprises the steps of:
(b1) selecting a set of patches, with each selected patch being located at least a minimum distance apart from each of the other selected patches;
(b2) for each selected patch, selecting a neighboring patch that has the closest similarity in orientation and then merging it therewith to form a new patch; and
(b3) repeating step (b2) for each patch until the resulting patch reaches or exceeds one of predetermined size limit and predetermined radius limit.

8. The method as claimed in claim 1, wherein step (d) comprises the steps of:
(d1) performing a series of edge collapse operations on the patches of the leaf level individually until each patch reaches a predetermined minimal resolution; and
(d2) repeating step (d1) for the patches of the next higher level and recursively until all the patches in the hierarchical mesh are simplified.

9. The method as claimed in claim 8, wherein each patch has a boundary including a plurality of vertices, and the edges joined to the boundary vertices are excluded from the edge collapse operations.

10. The method as claimed in claim 8, wherein the edge collapse operations are performed on the edges in a sequence chosen to minimise distortion of the simplified patches compared with the corresponding original patches.

11. The method as claimed in claim 8, wherein the simplified patches of each level have respective predetermined minimal resolutions prior to patch simplification at the next higher level.

12. The method as claimed in claim 8, wherein step (d1) includes constructing an ordered list of refinement records storing information indicating how respective edges of each patch are collapsed, which is useful for rendering the patch front one level to another.

13. The method as claimed in claim 12, wherein each refinement record comprises information relating to the two vertices of a corresponding collapsing edge, its two adjacent faces and the affected wedges.

14. A method of selective and progressive transmission of details of a geometric model represented by the hierarchical mesh generated according to the method of claim 12 to a receiver, comprising the steps of:
(A) selecting and transmitting a base mesh of the hierarchical mesh, the base mesh comprising the simplified root patch;
(B) determining at least one dynamic parameter relative to said receiver; and
(C) selecting and transmitting visible patches of the hierarchical mesh meeting the dynamic parameter, together with the associated refinement records for rendering the visible patches individually through a series of vertex split operations at said receiver for an optimal resolution.

15. The method as claimed in claim 14, wherein the dynamic parameter comprises an application or user specific run-time condition comprising virtual distance of the geometric model relative to said receiver.

16. The method as claimed in claim 14, wherein the dynamic parameter comprises an application or user specific run-time condition comprising moving velocity of the geometric model relative to said receiver.

17. The method as claimed in claim 14, wherein the dynamic parameter comprises an application or user specific run-time condition comprising angular distance of the geometric model from said receiver's line of sight.

18. The method as claimed in claim 14, wherein step (C) includes transmitting patches of intermediate levels between the base mesh and the visible patches progressively from one level to a lower level, together with the associated refinement records for transitional rendering at increasing resolution.

19. A method of selectively adding or removing details to or from a desired region of a geometric model represented by the hierarchical mesh generated according to the method of claim 1, comprising steps of:
(I) representing the geometric model by rendering selected patches of the hierarchical mesh, the patches representing unique regions of the geometric model including the desired region;
(II) performing a patch split operation on the patch representing the desired region by replacing the patch with patches representing the same region at the next lower level, whereby details are added to the desired region; or
(III) performing a patch collapse operation on the patch representing the desired region and neighboring patch or patches of the same level by replacing such patches with a patch of the next higher level, whereby details are removed from the desired region.

20. The method as claimed in claim 19, wherein the patch collapse operation of step (III) comprises a series of edge collapse operations.

21. The method as claimed in claim 19, wherein the patch split operation of step (II) comprises a series of vertex split operations.

22. A data structure based on the hierarchical mesh generated according to the method of claim 1 for representing a geometric model comprising a plurality of connected triangular faces, for selective and progressive transmission and rendering, which data structure comprises:
a tree of patches of progressively higher levels from a leaf level to a root level, each patch of each level other than the leaf level being a union of respective connected patches of the next lower level, the patches being simplified recursively from the leaf level to the root level, such that the patches of each level represent respective regions of the geometric model at a resolution that is progressively reducing from the leaf level to the root level.
a base mesh comprising at least one simplified root patch of the root level; and
a tree of refinement lists storing information indicating how the patches are simplified.

23. The data structure as claimed in claim 22, wherein the patches are arranged in a parent-child manner as the tree of patches, with child patches of one level united into a corresponding parent patch of the next higher level.

24. The data structure as claimed in claim 22, wherein each refinement list comprises a list of refinement records for an associated patch, storing information indicating how its edges are collapsed in a series of operations for patch simplification.
